(19) United States
(12) Patent Application Publication
(10) Pub. No.: US 2003/0043396 A1
(43) Pub. Date: Mar. 6, 2003

(54) Printer driver access interface

(76) Inventors: Elliot L. Klosterman, Boise, ID (US); James DuBois, Star, ID (US); James A. Hewitt, Meridian, ID (US); Dennis W. Howard, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/943,239

(22) Filed: Aug. 29, 2001

(51) Int. Cl. B41B 1/00; G06F 15/00

(52) U.S. Cl. 358/1.13; 358/1.15

(57) ABSTRACT

An interface module mediates between a printer driver and at least one add-on module, allowing the printer driver to call at least one add-on module via the interface module. One or more add-on modules are registered with the interface module, independent from the printer driver. One or more add-on modules may modify the user interface presented by the printer driver. As a print stream passes through the printer driver, one or more add-on modules may add data to the print stream at one or more access points. In this way, the interface module allows for greater control over the print stream and the user interface.

### FIELD OF THE INVENTION

This invention relates to printing, and more particularly to an interface module associated with a printer driver.

### BACKGROUND

Referring to FIG. 1, an information handling system 2 is connected to a printing device 4 via a cable. Such a connection may be made, for example, through a serial or parallel interface. The information handling system 2 instead may be connected to the printing device 4 via wireless transmission, for example, through wireless communication in the infrared band. The information handling system 2 may be a personal computer, a network appliance, a handheld computer, a personal digital assistant, or other such device. The printing device 4 may be a laser printer, ink jet printer, or other kind of printing device. The connection of an information handling system 2 to a printing device 4 in order to print information is well known.

Referring to FIG. 2, the information handling system 2 generally is controlled by an operating system, which generates an operating system environment 6. The operating system may be any operating system that is adapted to control an information handling system 2, such as Microsoft Windows, the Apple OS, or the Palm OS. The printer driver 8 is software that functions within the operating system environment 6 and enables a software application running in the operating system environment 6 to communicate with a printing device 4. The printer driver 8, as well as the operating system, are typically stored in a memory storage device within the information handling system 2, such as a hard drive, optical drive, flash memory, memory card, proprietary memory, or any other physical device adapted to store data. The printer driver 8 typically is loaded into the operating system environment 6 as needed. The use of a printer driver 8 in an operating system environment 6 is standard in the art.

When a software application running in the operating system environment 6 initiates a print job, it transmits print output to the printer driver 8. As used in this document, the phrase “print job” refers to the set of data that describes the sum total of print output from the software application, along with any overhead data. These terms may be best understood by example. Referring to FIG. 3, a document 12 includes two individual pages 14. As an example, the document 12 may be a two-page text document generated in the Microsoft Word application. If the single document 12 is selected for printing from that software application, then the document 12 constitutes the print job. Referring to FIG. 4, a document 12 includes at least one physical page 14, where each physical page 14 may include one or more logical pages 16. A logical page 16 is a standard output page compressed such that more than one logical page 16 can be fit on to a single physical page 14. In this way, paper and toner resources may be conserved. This compression of multiple logical pages to one physical page is often performed by the printer driver 8 in response to control settings input to and stored by the printer driver 8. The use of logical pages 16 in conjunction with physical pages 14 is standard in the art. As shown in FIG. 4, the document 12 is within a print stream 18. As used in this document, the phrase “print stream” refers to the data stream constituting the print job as that data is transmitted through the printer driver 8, along with any overhead added to the print job at any point as it transits between the software application and the printing device 4.

The printer driver 8 converts a received print job into a format that can be understood by the printing device 4. The printer driver 8 then transmits the print job to the printing device 4. The printer driver 8 typically includes information relating to a particular model of printing device 4 connected to the information handling system 2. In this way, the printer driver 8 is able to accurately convert the print output from the software application into a format understood by a particular printing device 4.

It may be desirable to customize the printer driver 8 for various reasons. For example, it may be desirable to change the user interface (UI) displayed by the printer driver 8 to the user when a print job is initiated. The UI is typically a dialog box or other graphical or textual information displayed to a user. Changes to the UI may include offering to the user additional options relating to the print job via additional buttons, tabs, UI pages, or the like. It is known to customize the printer driver 8 through the use of a single add-on module, such as a dynamic link library (DLL) file. A DLL file is a library of executable functions or data that can be used by an application running in the operating system environment 6. Typically, a DLL provides one or more particular functions and a program accesses the functions by creating either a static or dynamic link to the DLL. A static link remains constant during program execution while a dynamic link is created by the program as needed. A DLL may contain solely data, without executable functions. DLL files are not loaded into random access memory with a software application that utilizes it upon launch of the software program. Rather, a DLL file is not loaded until it is called by the software application. Thus, a DLL file used as an add-on module 10 is typically loaded into random access memory upon initiation of a print job. The use of DLLs is known in the art.

Existing printer drivers 8 only allow for a single add-on module 10 to be utilized. The add-on module 10 may be used to modify the UI, insert commands into the print stream at one or more fixed and preset access points, access preset settings within the printer driver 8, and/or perform other functions. As used in this document, the phrase “access points” refers to discernible locations in the print stream, the detection of which may trigger an action. For example, upon detecting an access point in the print stream, the add-on module 10 may insert data into the print stream.

Existing printer drivers 8 and existing add-on modules 10 have several disadvantages. Existing printer drivers 8 do not allow for usage of more than one add-on module 10. Further, existing add-on modules 10 do not allow for insertion of data or commands into the print stream at different locations for different print jobs. Instead, such add-on modules 10 only allow for insertion of data or commands into the print stream at the same access point or points for every print job. Further, if more than one printer driver 8 is used in the operating system environment 6, in order to connect to multiple printing devices 4, existing solutions require a different add-on module 10 to be used with each printer driver 8. As another disadvantage, changing or updating the add-on module 10 requires the reinstallation of the printer driver 8, which may be time consuming and inconvenient, or impossible if the user has lost the storage medium on which a backup copy of the printer driver 8 is stored.

The Adobe Corporation has provided for the utilization of a single add-on module 10 with a corresponding printer driver 8, where that add-on module 10 is a DLL. A single add-on module 10 may be used with a particular printer driver 8, where that add-on module may modify or add the UI, insert commands into the print stream at one or more preset and fixed access points, and access predefined printer driver 8 settings. Similarly, Microsoft allows the development and usage of add-on modules 10 utilizing its Component Object Model (COM) technology, rather than DLL files. However, as with add-on modules 10 that utilize DLL files, the COM technology only allows for limited predefined UI modifications and the insertion of limited commands into preset fixed locations in the print stream. Both of these implementations of add-on modules 10 have the general disadvantages described above.

### SUMMARY

An interface module mediates between a printer driver and at least one add-on module, allowing the printer driver to call at least one add-on module via the interface module.

In one aspect of the invention, an interface module interfaces with a printer driver, as well as with at least one add-on module. The printer driver calls the add-on modules via the interface module, rather than directly. In this way, multiple add-on modules can be accessed and loaded by the printer driver. By providing an interface module between the add-on modules and multiple printer drivers, the same add-on module can be loaded by different printer drivers. The use of the interface module in conjunction with the printer driver allows for efficient management and use of multiple add-on modules.

In another aspect of the invention, upon the occurrence of a particular event, at least one add-on module or component thereof is loaded via the interface module. The particular event may be the beginning of a print job or a print stream. The loaded add-on module or component may then obtain data from or transmit data to the printer driver via the interface module. Such data may include status, settings, or other information. This data may be transmitted at the beginning of a print job or print stream, or at one or more access points within the print stream, such as the beginning and end of a document, the beginning and end of each physical page of the document, and the beginning and end of each logical page of the document. In this way, the interface module allows for greater control over the print stream and enhanced compatibility between add-on modules and the printer driver.

In another aspect of the invention, an add-on module or component thereof loaded into the printer driver may add data to the print stream at one or more access points. The at least one add-on module and/or component may also monitor the print stream and/or perform other actions on the print stream at one or more access points. The add-on module may dynamically choose access points within the print stream, such that different access points may be utilized for different print jobs. In this way, the interface module allows for greater control over the print stream and enhancement of the finished printed product.

In another aspect of the invention, upon installing an add-on module onto an information handling system utilizing a printer driver, the interface module queries the add-on module. The add-on module may include a data structure that includes information relating to its properties, such as an identification of the model or models of printing device with which it is compatible. The interface module receives some or all of that data structure from the add-on module. In turn, the interface module may pass on to the printer driver some or all of the data received from the add-on module. In this way, the interface module facilitates the addition and/or upgrading of one or more add-on modules.

In another aspect of the invention, an add-on module may add one or more pages or other components to the user interface generated by the printer driver. In conjunction with generating a user interface, the printer driver calls the interface module to determine if any add-on modules have modifications to the user interface. If so, the interface module calls those components from the add-on modules and passes them to the printer driver, where they are loaded into the user interface. The user interface is then displayed to a user. In this way, the user interface displayed by the printer driver can be modified as needed by at least one add-on module, without the need to directly access or modify the printer driver itself.

The invention will be more fully understood upon consideration of the detailed description below, taken together with the accompanying drawings.

### BRIEF DESCRIPTION OF THE DRAWINGS

FIG. 1 is a block diagram of an information handling system and a printing device.

FIG. 2 is a block diagram of a prior art printer driver and add-on module.

FIG. 3 is a block diagram of a document printed via the print driver.

FIG. 4 is a block diagram of a print stream.

FIG. 5 is a block diagram of the operating environment of an interface module utilized in conjunction with a printer driver.

FIG. 6 is a flow chart illustrating the method of operation of the interface module in conjunction with the printer driver and one or more add-on modules.

FIGS. 6A-6B continue the flow chart of FIG. 6.

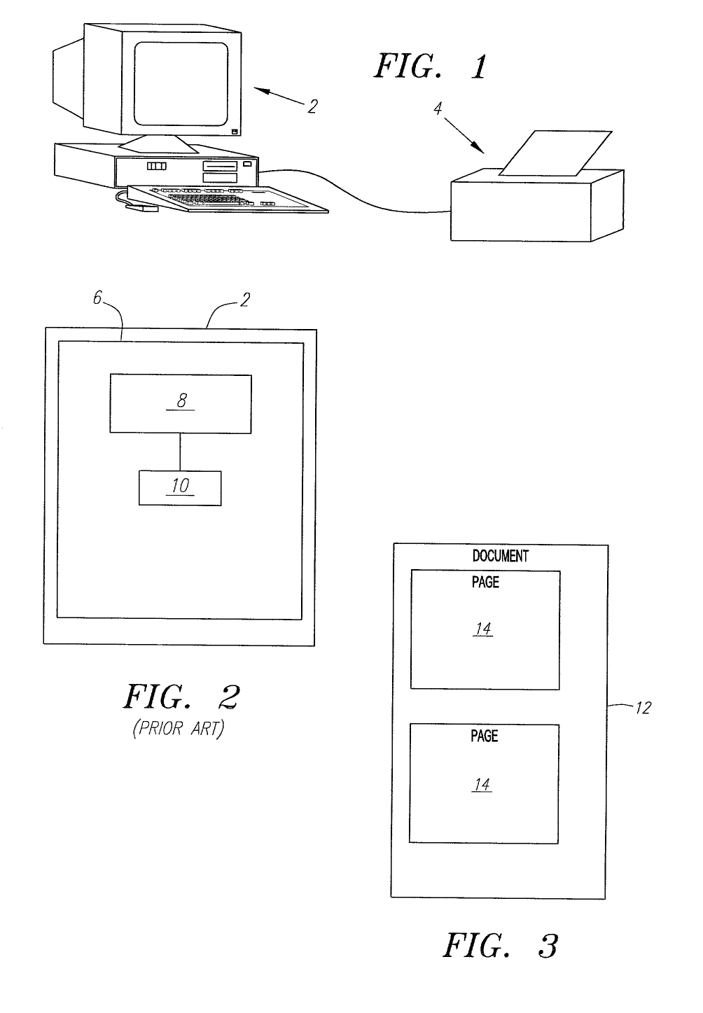

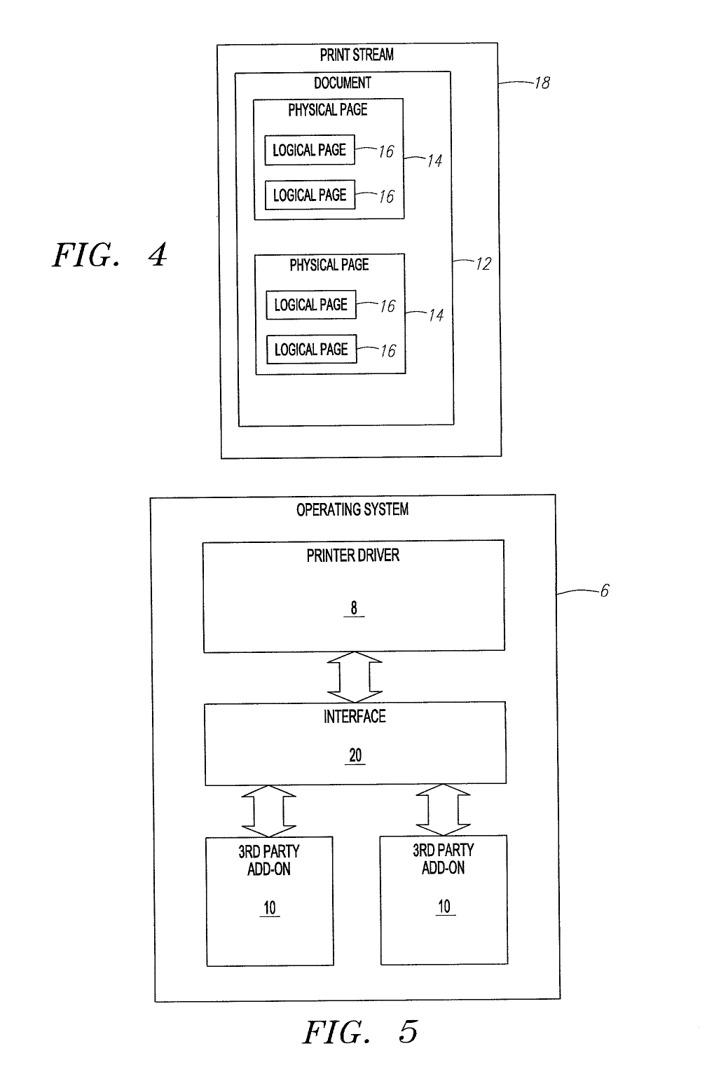

Use of the same reference symbols in different figures indicates similar or identical items.

### DETAILED DESCRIPTION OF THE PREFERRED EMBODIMENTS

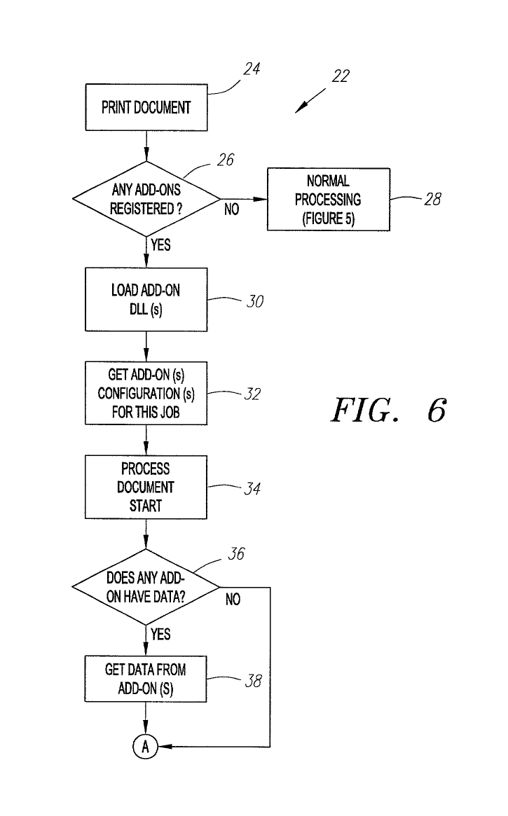

Referring to FIG. 5, an interface module 20 is shown. The interface module 20 interfaces with the printer driver 8, and runs within the operating system environment 6. At least one add-on module 10 interfaces with the interface module 20. Each add-on module 10 may perform a different function or set of functions, such as inserting data into the print stream or modifying the UI generated by the printer driver 8. For example, different add-on modules 10 may be obtained from different software developers, and used in conjunction with one another. The add-on modules 10 may be DLL files, files in Microsoft's COM format, or files in another format or language. In one embodiment, each add-on module 10 includes a data structure that includes information relating to its properties, such as an identification of the model or models of printing device with which it is compatible, and/or an identification of the functionality of the add-on module 10. In one embodiment, an Application Program Interface (API) between the interface module 20 and the add-on modules 10 is identical across operating systems. That is, the interface module 20 and the add-on modules 10 communicate with one another in the same manner, with the same parameters passed between them, regardless of the operating system utilized. The printer driver 8 and the add-on modules 10 are specific to different operating systems, due to requirements of each particular operating system. However, these specific changes made to the add-on modules 10 do not change the API between the add-on modules 10 and the interface module 20.

The interface module 20 is a set of instructions used in conjunction with the printer driver 8. The language in which the interface module 20 is written is not critical to the invention. In one embodiment, the interface module 20 receives a call from the printer driver 8, where that call would call an add-on module 10 directly in the absence of the interface module 20. The interface module 20 then determines which add-on modules 10 are registered to respond to that call. Registration is described in greater detail below. Then, the interface module 20 sequentially loads each responsive add-on module 10, then unloads it when its function or functions have been completed. In this way, the printer driver 8 only operates in conjunction with one add-on module 10 at a time. Thus, the printer driver 8 need not be modified in order to call multiple add-on modules 10. That is, the call issued by the printer driver 8 to load a single add-on module 10 is utilized by the interface module 20 to load multiple add-on modules, without necessitating changes to the printer driver 8. The installation and registration of one or more add-on modules 10 is thus independent from the printer driver 8. The interface module 20, as well as one or more add-on modules 10, may be stored in a memory storage device within or connected to the information handling system 2, until being loaded into the operating system environment 6.

Each add-on module 10 registers with the interface module 20 as part of its installation onto the information handling system 2. Upon installing an add-on module 10 onto an information handling system 2, the interface module 20 queries the add-on module 10. As described above, in one embodiment each add-on module 10 includes include a data structure that includes information relating to its properties. This information may be referred to as “property information”. That data structure includes information relating to the type of call from the printer driver 8 that loads the add-on module 10. For example, if the add-on module 10 is designed to be loaded when the printer driver 8 issues a call relating to the display of the user interface, the interface module 20 stores that property information upon installation. As another example, if the add-on module 10 is designed to be loaded when the printer driver 8 issues a call relating to reaching an access point in a print stream, the interface module 20 stores that property information upon installation. The interface module 20 reads some or all of that data structure from the add-on module, and stores that data. By storing this information, the interface module 20 is able to load sequentially multiple add-on modules 10 upon the receipt of calls from the printer driver 8, as described in greater detail below. Further, the interface module 20 may store other information relating to the add-on module 10, such as its location in memory in the information handling system 2 or in an associated memory storage device. By installing and registering the add-on modules 10 in this manner, the printer driver 8 need not be reinstalled upon installation of one or more add-on modules 10. That is, the add-on modules 10 are registered with the interface module 20 rather than the printer driver 8, such that installation of a new add-on module 10 or an upgrade to an existing add-on module 10 may be performed without disturbing the printer driver 8.

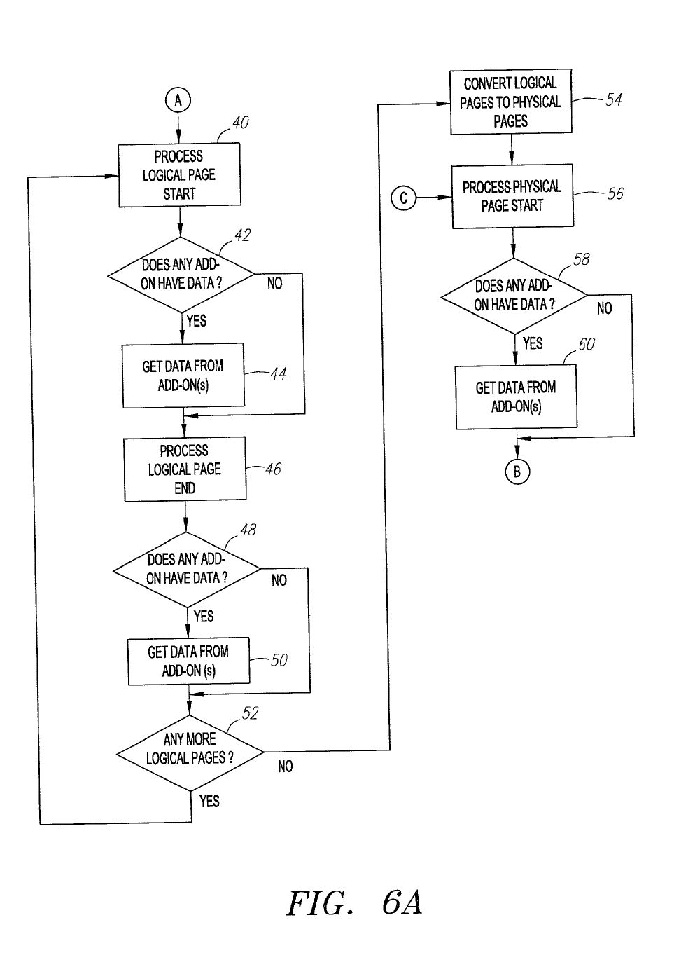

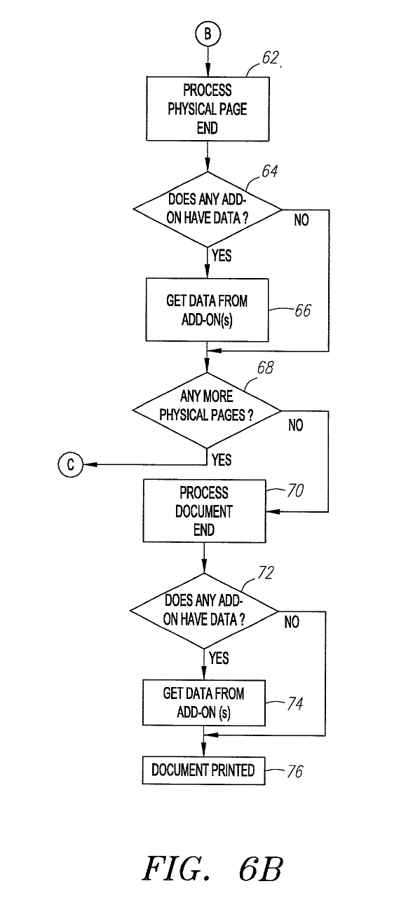

Referring to FIGS. 6-6B, a method 22 for printing a document 12 utilizing the interface module 20 and the add-on modules 10 is shown. In block 24, the user instructs a software application to print a document 12. The instruction to print the document 12 initiates a print job containing the document 12. Instructing a software application to print a document and initiating a print job are standard to one skilled in the art.

The initiation of a print job brings up a UI on a display (not shown) associated with the information handling system 2. Typically, if the user wishes to change certain settings of the printing device 4, the user does so via a button, tab, or other control in the UI, which may bring up a separate window or page through which those settings may be changed. To display the printing device 4 settings and/or a UI window, page or other control associated with those printing device 4 settings, the software application from which the print job is to be initiated typically calls the printer driver 8. In turn, the printer driver 8 calls the interface module 20. The interface module 20, having received that call from the printer driver 8, determines whether any of the add-on modules 10 are responsive to it. As described above, the interface module 20 stored data relating to the functions of each add-on module 10, and checks that data to determine whether any of the add-on modules 10 are responsive to the call. An add-on module 10 that is responsive to the call contains data or commands for modifying the UI. If so, the interface module 20 sequentially connects the responsive add-on module or modules 10 to the printer driver 8. Each add-on module 10 in turn passes its UI modifications to the printer driver 8 via the interface module 20. That data and/or those one or more commands are then displayed to the user as part of the UI.

If the information handling system 2 is connected to more than one printing device 4, as through a network, the information handling system 2 typically defaults to the use of a selected printing device 4. Typically, each different printing device 4 has a separate printer driver 8. Thus, when the UI calls the printer driver 8 above, it calls the printer driver 8 associated with the default printing device 4. The user may select a different printing device 4 via the UI. If so, the printer driver 8 utilized by the information handling system 2 changes as well. In one embodiment, a separate interface module 20 is uniquely associated with each printer driver 8. Each add-on module 10 then registers with each interface module 20 upon installation. In this way, each add-on module 10 may be called by multiple printer drivers 8, as appropriate. The functionality of each add-on module 10 is thereby more easily shared among multiple printing devices 4 utilized by the information handling system 2. Further, memory storage space is conserved by using the same add-on module 10 in conjunction with different printer drivers 8.

The process 22 moves to block 26, in which the interface module 20 determines whether any add-on modules 10 are registered with the interface module 20 utilized in conjunction with the printer driver 8 handling the print job. Determining whether any add-on modules 10 are registered with the interface module 20 may include querying a registry or an address in a memory storage device associated with the information handling system 2 where property information is stored. If no add-on modules 10 are registered with the interface module 20, then the process 22 moves to block 28, in which the print job is processed in a normal manner. The normal processing of a print job through a printer driver 8 to a printing device 4 is standard to one skilled in the art. If one or more add-on modules 10 are registered with the interface module 20, then the process 22 moves to block 30.

In block 30, add-on modules 10 that are registered with the interface module 20 are loaded. Loading refers to copying one or more add-on modules 10 from a relatively slow memory storage device (such as a hard drive) to relatively fast memory (such as random-access memory). In this way, the add-on modules 10 are accessible within the operating system environment 6 without excessive delay.

In block 32, the interface module 20 issues a call to each add-on module 10 loaded in block 30, in order to determine the configuration of each add-on module 10 for the current print job. Each add-on module 10 may respond to a different access point or access points for different print jobs, depending on the settings stored in each add-on module 10 or printer driver 8. The interface module 20 uses this configuration information to determine which add-on modules 10 will be responsive to each print stream access point.

In block 34, the printer driver 8 processes the start of the document 12. The print job containing the document 12 is transmitted to the printer driver 8 from a software application as a print stream 18, as described above. The printer driver 8 receives the print stream 18, and recognizes the part of the print stream 18 associated with the start of the document 12. The printer driver 8 also issues a call to the interface module 20, where that call indicates that the start of the document 12 has been reached. That is, the call indicates that an access point to the print stream 18 has been reached. The interface module 20 receives that call.

In block 36, the interface module 20, having received that call from the printer driver 8, determines whether any of the add-on modules 10 are responsive to it, using the property information determined previously. An add-on module 10 responsive to the call contains data or commands for insertion into the print stream 18 at the document start access point, which is the first access point in the print stream. As described above, the interface module 20 checks earlier-stored property information to determine whether any of the add-on modules 10 are responsive to the call. If not, the process moves to block 40. If so, the process moves to block 38.

In block 38, the interface module 20 sequentially connects the responsive add-on module or modules 10 to the printer driver 8. In this way, the printer driver 8 only interfaces with a single add-on module 10 at a time. Thus, a standard printer driver 8 may be used, and the interface module 20 allows that standard printer driver 8 to be used in conjunction with more than one add-on module 10. The responsive add-on module or modules 10 may contain data such as macros for performing a save operation at the beginning of the document 12, or one or more commands associated with the beginning of the document 12. Each add-on module 10 in turn passes its data and/or commands to the printer driver 8 via the interface module 20. That data and/or those one or more commands are inserted by the printer driver 8 into the print stream 18 at the first access point at the start of the document 12. Instead of, or in addition to, inserting data or commands into the print stream 18, one or more add-on modules 10 may transmit a command to the printer driver 8 itself to change or adjust a setting within the printer driver 8. In this way, the add-on modules 10 can adjust the printer driver 8 as needed at the first access point. The process then moves to block 40.

In block 40, the printer driver 8 processes the start of a logical page 16 of the document 12. The printer driver 8 recognizes the part of the print stream 18 associated with the start of a logical page 16 of the document 12. The printer driver 8 also issues a call to the interface module 20, where that call indicates that the start of a logical page 16 of the document 12 has been reached. That is, the call indicates that an access point to the print stream 18 has been reached. The interface module 20 receives that call.

In block 42, the interface module 20, having received that call from the printer driver 8, determines whether any of the add-on modules 10 are responsive to it, using the property information determined previously. An add-on module 10 responsive to the call contains data or commands for insertion into the print stream 18 at the access point at the start of the logical page 16. As described above, the interface module 20 checks earlier-stored property information to determine whether any of the add-on modules 10 are responsive to the call. If not, the process 22 moves to block 46. If so, the process 22 moves to block 44.

In block 44, the interface module 20 sequentially connects the responsive add-on module or modules 10 to the printer driver 8. The responsive add-on module or modules 10 may contain data such as graphics or text for printing at the beginning of the logical page 16, or one or more commands associated with the beginning of the logical page 16. Each add-on module 10 in turn passes its data and/or commands to the printer driver 8 via the interface module 20. That data and/or those one or more commands are inserted in the print stream 18 at the access point at the start of the logical page 16. Instead of, or in addition to, inserting data or commands into the print stream 18, one or more add-on modules 10 may transmit a command to the printer driver 8 itself to change or adjust a setting within the printer driver 8. The process then moves to block 46.

In block 46, the printer driver 8 processes the end of a logical page 16 of the document 12. The printer driver 8 recognizes the part of the print stream 18 associated with the end of a logical page 16 of the document 12. The printer driver 8 also issues a call to the interface module 20, where that call indicates that the end of a logical page 16 of the document 12 has been reached. That is, the call indicates that an access point to the print stream 18 has been reached. The interface module 20 receives that call.

In block 48, the interface module 20, having received that call from the printer driver 8, determines whether any of the add-on modules 10 are responsive to it. An add-on module 10 responsive to the call contains data or commands for insertion into the print stream 18 at the access point at the end of the logical page 16. As described above, the interface module 20 checks earlier-stored property information to determine whether any of the add-on modules 10 are responsive to the call. If not, the process moves to block 52. If so, the process 22 moves to block 50.

In block 50, the interface module 20 sequentially connects the responsive add-on module or modules 10 to the printer driver 8. The responsive add-on module or modules 10 may contain data such as graphics or text for printing at the end of the logical page 16, or one or more commands associated with the end of the logical page 16. Each add-on module 10 in turn passes its data and/or commands to the printer driver 8 via the interface module 20. That data and/or those one or more commands are inserted in the print stream 18 at the access point at the end of the logical page 16. Instead of, or in addition to, inserting data or commands into the print stream 18, one or more add-on modules 10 may transmit a command to the printer driver 8 itself to change or adjust a setting within the printer driver 8. The process then moves to block 52.

In block 52, if an additional logical page 16 follows in the print stream 18, the process 22 returns to block 40. If no additional logical page 16 follows in the print stream 18, the process 22 continues to block 54. In block 54, the printer driver 8 converts logical pages 16 to physical pages 14, depending on various printer driver 8 settings. For example, a printer driver 8 setting of two pages per sheet causes the printer driver 8 to collect two logical pages 16 and format them to fit onto a single physical page 14. This conversion process applies to all data and commands on and associated with the logical pages 16, whether generated by the printer driver 8 or an add-on module 10. The conversion of logical pages 16 to physical pages 14 by software such as the printer driver 8 is standard in the art.

In block 56, the printer driver 8 processes the start of a physical page 14 of the document 12. The printer driver 8 recognizes the part of the print stream 18 associated with the start of a physical page 14 of the document 12. The printer driver 8 also issues a call to the interface module 20, where that call indicates that the start of a physical page 14 of the document 12 has been reached. That is, the call indicates that an access point to the print stream 18 has been reached. The interface module 20 receives that call.

In block 58, the interface module 20, having received that call from the printer driver 8, determines whether any of the add-on modules 10 are responsive to it. An add-on module 10 responsive to the call contains data or commands for insertion into the print stream 18 at the access point at the start of the physical page 14. As described above, the interface module 20 checks earlier-stored property information to determine whether any of the add-on modules 10 are responsive to the call. If not, the process 22 moves to block 62. If so, the process 22 moves to block 60.

In block 60, the interface module 20 sequentially connects the responsive add-on module or modules 10 to the printer driver 8. The responsive add-on module or modules 10 may contain data such as graphics or text for printing at the beginning of the physical page 14, or one or more commands associated with the beginning of the physical page 14. Each add-on module 10 in turn passes its data and/or commands to the printer driver 8 via the interface module 20. That data and/or those one or more commands are inserted in the print stream 18 at the access point at the start of the physical page 14. Instead of, or in addition to, inserting data or commands into the print stream 18, one or more add-on modules 10 may transmit a command to the printer driver 8 itself to change or adjust a setting within the printer driver 8. The process then moves to block 62.

In block 62, the printer driver 8 processes the end of a physical page 14 of the document 12. The printer driver 8 recognizes the part of the print stream 18 associated with the end of a physical page 14 of the document 12. The printer driver 8 also issues a call to the interface module 20, where that call indicates that the end of a physical page 14 of the document 12 has been reached. That is, the call indicates that an access point to the print stream 18 has been reached. The interface module 20 receives that call.

In block 64, the interface module 20, having received that call from the printer driver 8, determines whether any of the add-on modules 10 are responsive to it. An add-on module 10 responsive to the call contains data or commands for insertion into the print stream 18 at the access point at the end of the physical page 14. As described above, the interface module 20 checks earlier-stored property information to determine whether any of the add-on modules 10 are responsive to the call. If not, the process 22 moves to block 68. If so, the process 22 moves to block 66.

In block 66, the interface module 20 sequentially connects the responsive add-on module or modules 10 to the printer driver 8. The responsive add-on module or modules 10 may contain data such as graphics or text for printing at the end of the physical page 14, or one or more commands associated with the end of the physical page 14. Each add-on module 10 in turn passes its data and/or commands to the printer driver 8 via the interface module 20. That data and/or those one or more commands are inserted in the print stream 18 at the access point at the end of the physical page 14. Instead of, or in addition to, inserting data or commands into the print stream 18, one or more add-on modules 10 may transmit a command to the printer driver 8 itself to change or adjust a setting within the printer driver 8. The process then moves to block 68.

In block 68, if an additional physical page 14 follows in the print stream 18, the process 22 returns to block 56. If no additional physical page 14 follows in the print stream 18, the process 22 continues to block 70. In block 70, the printer driver 8 processes the end of the document 12. The printer driver 8 recognizes the part of the print stream 18 associated with the end of the document 12. The printer driver 8 also issues a call to the interface module 20, where that call indicates that the end of the document 12 has been reached. That is, the call indicates that an access point to the print stream 18 has been reached. The interface module 20 receives that call.

In block 72, the interface module 20, having received that call from the printer driver 8, determines whether any of the add-on modules 10 are responsive to it. An add-on module 10 responsive to the call contains data or commands for insertion into the print stream 18 at the access point at the end of the document 12. As described above, the interface module 20 checks earlier-stored property information to determine whether any of the add-on modules 10 are responsive to the call. If not, the process 22 moves to block 76. If so, the process 22 moves to block 74.

In block 74, the interface module 20 sequentially connects the responsive add-on module or modules 10 to the printer driver 8. The responsive add-on module or modules 10 may contain one or more commands associated with the end of the document 12. Each add-on module 10 in turn passes its data and/or commands to the printer driver 8 via the interface module 20. That data and/or those one or more commands are inserted in the print stream 18 at the access point at the end of the document 12. Instead of, or in addition to, inserting data or commands into the print stream 18, one or more add-on modules 10 may transmit a command to the printer driver 8 itself to change or adjust a setting within the printer driver 8. The process then moves to block 76. In block 76, the document 12 has been printed, and the print job is complete.

As described above, one or more add-on modules may transmit data or commands to the printer driver 8 during processing of the print stream 18, at one or more access points. The access points in the print stream 18 that are utilized for insertion of data and/or commands may vary between print jobs. For example, in one print job, the only insertion of data and/or commands into the print stream 18 is a command at the end of the document. Continuing the example, in the next print job, data is inserted into the print stream 18 at each access point. That is, the access points in the print stream 18 are dynamically selectable, meaning that different access points may be utilized in different print jobs.

During processing of the print stream 18, one or more add-on modules 10 may query the printer driver 8 about one or more of its settings. These settings include any data or commands within the printer driver 8 relating to its processing of the print stream 18. In this way, the add-on module or modules 10 querying the printer driver 8 can monitor and change one or more of its own settings based on the response of the printer driver 8. The add-on module or modules 10 may query the printer driver 8 at one or more access points to the print stream 18, or may query the printer driver 8 between access points, before the first access point, or after the last access point.

Instructions for implementing the method 22 may be provided as a computer program product. A computer program product is a set of instructions for a device such as the information handling system 2. The computer program product may be stored in a memory storage device within or connected to the information handling system 2. The computer program product may be received into the information handling system 2 or associated device via a communications network, a compact disc, a removable hard disk, a removable optical disk, flash memory, or any other hardware, network, device or method capable of storing and/or transmitting data.

Although the invention has been described with reference to particular embodiments, the description is only an example of the invention's application and should not be taken as a limitation. Consequently, various adaptations and combinations of features of the embodiments disclosed are within the scope of the invention as defined by the following claims and their legal equivalents.

What is claimed is:

1. A method for processing a print stream through a printer driver, comprising:
providing an interface module that interfaces with the printer driver;
registering at least one add-on module with said interface module.

2. The method of claim 1, wherein said registering comprises:
receiving property information at said interface module from each said add-on module; and
storing said property information.

3. The method of claim 1, wherein said registering is independent from the printer driver.

4. The method of claim 1, further comprising:
receiving a call from the printer driver indicating that a print job is initiated;
determining whether any of said add-on modules are responsive to said call; and
in response to determining that at least one add-on module is responsive, sequentially connecting said at least one responsive add-on module to the printer driver via said interface module.

5. The method of claim 4, wherein said at least one responsive add-on module is adapted to modify a user interface generated by the printer driver.

6. The method of claim 1, wherein the print stream comprises at least one access point, further comprising:
receiving a call from the printer driver indicating that an access point has been reached;
determining whether any of said add-on modules are responsive to said call; and
in response to determining that at least one add-on module is responsive, sequentially connecting said at least one responsive add-on module to the printer driver via said interface module.

7. The method of claim 6, wherein said at least one responsive add-on module inserts data into the print stream at said access point.

8. The method of claim 6, wherein said at least one responsive add-on module inserts a command into the print stream at said access point.

9. The method of claim 6, wherein said at least one responsive add-on module transmits a command to the printer driver.

10. The method of claim 6, wherein said at least one access point is selected from the group consisting of a document start, a document end, a physical page start, a physical page end, a logical page start, and a logical page end.

11. The method of claim 6, wherein said at least one access point is dynamically selectable.

12. The method of claim 1, wherein the printer driver has at least one setting, further comprising:
querying the printer driver from at least one said add-on module about at least one said setting, and
receiving information from the printer driver in response to said querying.

13. The method of claim 12, wherein at least one said add-on module comprises at least one setting, further comprising changing a setting in at least one said add-on module in response to said received information.

14. The method of claim 1, wherein the printer driver has at least one setting, further comprising changing at least one said setting of the printer driver through said interface module under the control of at least one said add-on module.

15. The method of claim 1, further comprising providing at least one additional printer driver and a corresponding additional interface module for each additional printer driver, wherein at least one add-on module is registered with a plurality of said interface modules.

16. A computer program product for use in an information handling system, where an operating system environment is present on the information handling system, and at least one add-on module interfaces with a printer driver through an interface module within the operating system environment, the computer program product comprising:
instructions for registering at least one add-on module with the interface module.

17. The computer program product of claim 16, further comprising:
instructions for receiving a call from the printer driver indicating that a print job is initiated;
instructions for determining whether any of said add-on modules are responsive to said call; and
in response to determining that at least one add-on module is responsive, instructions for sequentially connecting said at least one responsive add-on module to the printer driver via said interface module.

18. The computer program product of claim 16, further comprising:
instructions for receiving a call from the printer driver indicating that an access point has been reached;
instructions for determining whether any of said add-on modules are responsive to said call; and
in response to determining that at least one add-on module is responsive, instructions for sequentially connecting said at least one responsive add-on module to the printer driver via said interface module.

19. The computer program product of claim 16, further comprising:
instructions for querying the printer driver about at least one setting therein; and
instructions for receiving information from the printer driver in response to said querying.

20. The computer program product of claim 16, wherein the printer driver has at least one setting, further comprising instructions for changing at least one said setting of the printer driver through said interface module under the control of at least one said add-on module.
